(19) United States
(12) Patent Application Publication
(10) Pub. No.: US 2007/0041077 A1
(43) Pub. Date: Feb. 22, 2007

(54) Pocket-sized two-dimensional image projection system

(75) Inventors: Cheong Soo Seo, Seongnam (KR); Gyoung Il Cho, Seoul (KR)

Correspondence Address: STEREO DISPLAY INC., 980 EAST ORANGETHORPE AVENUE, SUITE F, ANAHEIM, CA, 92801, US

(73) Assignees: Stereo Display, Inc., Anaheim, CA (US); Angstrom, Inc., Suwon (KR)

(21) Appl. No.: 11/208,114

(22) Filed: Aug. 19, 2005

(51) Int. Cl. G02B 26/00

(52) U.S. Cl. 359/291

(57) ABSTRACT

A pocket-sized two-dimensional image projection device adapted to a portable device is invented. The pocket-sized two-dimensional image projection device projects two-dimensional image on a projection surface with arbitrary profile and arbitrary distance from the projection device, and arbitrary attitude about the projection device. The position, profile, and attitude of the projection surface about the projection device can be arbitrary because the projection surface is not embodied in the projection device to reduce size of the device. Each micromirror array lens has the ability of scanning and focusing on the projection surface. The focusing on the projection surface can be achieved by automatic focusing function of micromirror array lens. Therefore, an in-focused two-dimensional image can be displayed on arbitrary projection surface. Also, this invention makes a brighter and less power consuming display device, which give an advantage for the portable device application.

### BACKGROUND OF THE INVENTION

Conventional portable devices with physical display can not increase display size. But the portable device with projector can make a large display. Pocket-sized projectors can make people to see a high-resolution display from a camera, a cellular phone, an organizer, PDA, DVD player, laptop computer, and etc. Power consumption is an important issue for portable devices because the projector draws power from the device such as camera, cellular phone, an organizer, PDA, etc.

Spatial light modulators (SLM) have been used in projection display systems to increase image resolution and display brightness. For example, a Digital Micromirror Device (DMD) array, as described in U.S. Pat. Nos. 5,535,047 and 6,232,936, was used for two-dimensional image projection devices. According to this teaching, each micromirror of the DMD array has single-degree-of-freedom rotation about an axis, and works as a simple optical switch. Since the DMD array is merely an array of optical switches, the direction of light is limited. As shown in FIG. 1, the DMD array has only two positions; one is the “on” position and the other is the “off” position. When the DMD array is applied to a two-dimensional image projection device such as projectors and projection televisions, simple “on-off” behavior limits its light efficiency and becomes the main reason for high power consumption. According to the prior art, the DMD array uses at most fifty percent (50%) of incident light because it only has “on” or “off” position. In that regard, the light is dumped when the mirror is at its “off” position. In order to improve brightness and power efficiency of two-dimensional image projection system, most of the reflected light should be projected onto the screen.

There is a practical need for a pocket-sized two-dimensional image projection system that incorporates the advanced focusing capabilities of micromirror array lenses to improve brightness and power efficiency, and reducing size over existing projection systems. It is desired that such system be easy to manufacture and capable of being used with existing two-dimensional projections systems and devices.

### SUMMARY OF THE INVENTION

The present invention is directed to a pocket-sized two-dimensional projection device for displaying two-dimensional images. The device comprises one micromirror array lens(MMAL) or array of MMAL. Each MMAL comprises an arbitrary group of micromirrors. The optical property of each group of micromirrors can vary according to the displayed image. The micromirrors are individually controlled electrostatically and/or electromagnetically by actuating components. The micromirrors are provided with three-degree-of-freedom motion; one translational motion along the normal axis to the plane of lens and two rotational motions about the axes in the plane. The translational motion is required to meet the phase matching condition to compensate for aberrations. The two rotational motions are required to deflect and focus the light, and are essential to the versatility of the array of MMAL.

In use, the device comprises a light source that generates collimated light which incidents from the light source to the lens array. The light is reflected from the micromirror array lenses and focused onto a projection surface where the resulting image is viewed. Since each micromirror array lens has the ability to scan the in-focused light along the projection surface, any two or more micromirror array lenses can simultaneously focus incident light onto different positions or at the same position on the projection surface. Because each micromirror array lens can scan the whole projection surface (i.e., focus the incident light at any position on the projection surface), the projected image can be generated.

When a MMAL or array of MMALs is applied to the pocket-sized two-dimensional image projection devices, the size of the device, the brightness of the projected image, and power consumption of the display device are greatly improved over prior art, DMD array devices and other projectors. The array of MMALs can use most incident light by adopting an optimized Random Scanning Technique. In accordance with this technique, a random scanning processor analyses brightness of each frame, and optimizes the focusing position and scanning speed of each micromirror array lens. For the purposes of the present invention, “random” means scanning is not to be sequential. Accordingly, in order to optimize the set of MMAL combinations which can minimize the movement, minimize construction and destruction of MMAL, and minimize scanning length for a frame rate, each micromirror array lens: (a) has an arbitrary number of micromirors; (b) scans a projection surface with different speeds; and (b) focus light at random positions in the projection surface.

The random scanning technique also enables the number of micromirrors to be less than the number of image pixels without deterioration of the resolution of projected images. Therefore, the size of device can be reduced. The gray scale of each pixel is easily achievable by controlling scanning speed and/or by controlling the number of micromirrors of each MMAL.

A MMAL or small sized array of MMALs can be implemented in portable electronic equipments such as mobile phones, personal digital assistants (PDA), camcorder, or even laser pointers. In such devices, a MMAL or the array of MMALs is combined with a laser diode modules and an automatic focusing unit to provide a very small pocket-sized two-dimensional image projector. Such devices also enable users to view large projected images from their mobile phones, personal digital assistants (PDA), and so on.

In conclusion, the advantages provided by the present invention over image projection systems of the prior art are:

It improves brightness and power consumption of a two-dimensional image projection systems;

It provides a portable, pocked-sized, and high quality two-dimensional image projectors;

The present invention may be used in a variety of applications because each micromirror array lens of the array of MMALs can be controlled independently to have different focal length, different optical axis, lens size, and lens shape;

Each micromirror array lens can be controlled to scan a projection surface with different speeds to easily control the light intensity of the displayed image; and

A group of micromirrors of the lens array can be controlled to scan the same point simultaneously to easily control the light intensity of the displayed image.

### BRIEF DESCRIPTION OF THE DRAWINGS

These and other features, aspects and advantages of the present invention will be better understood by reference to the following detailed description when considered in conjunction with the accompanying drawings, wherein:

FIG. 1 is an illustration of the two stable deflected states of a prior art pixel mirror for deflecting incident light in one of two directions;

FIG. 2 is a schematic view of a pocket-sized two-dimensional image projection device in accordance with the present invention;

FIG. 3 is a partial top view of a lens array in accordance with the present invention;

FIGS. 4(a) and (b) are top views of the micromirror array lenses comprising the lens array of FIG. 3;

FIG. 5 is a top view of an array of micromirror array lenses at a first point in time, in accordance with principles of the present invention;

FIG. 6 is a top view of an array of micromirror array lenses at a another point in time, in accordance with principles of the present invention;

FIG. 7 is a schematic side view of a micromirror array lens in accordance with the present invention;

FIG. 8 is a perspective view showing the degrees-of-freedom of a micromirror in accordance with the present invention;

FIG. 9 is a schematic view illustration how a pocket-sized two-dimensional image projection device projects two-dimensional image on the projection plane in accordance with the present invention works;

FIG. 10 is a schematic view illustration how the pocket-sized two-dimensional image projection device projects two-dimensional image on a tilted and/or uneven surface;

FIG. 11 is a block diagram describing the random scanning technique of pocket-sized two-dimensional image projection devices of the present invention;

FIG. 12 is a block diagram describing a self diagnosis and correction process for pocket-sized two-dimensional image projection devices of the present invention; and

FIG. 13 is a schematic diagram of an electronic device comprising a lens array according to the principles of the present invention.

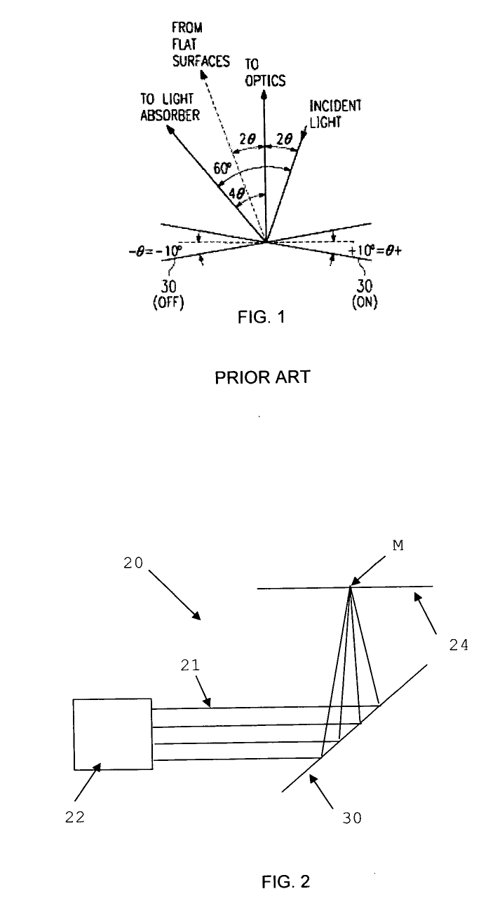

### DETAILED DESCRIPTION

In a particularly preferred embodiment of the invention, there is provided a pocket-sized two-dimensional image projection device comprising one micromirror array lens(MMAL) or array of MMAL. Each MMAL comprises a plurality of micromirrors, whose configurations may be adjusted to change the focal length, optical axis, lens size, the number of lenses, shape of lens, and others of the micromirror array lens. When applied to conventional two-dimensional display devices, the array of micromirror array lenses greatly improves the brightness of the projected image and the power consumption of the display device by increasing light efficiency and the size of projection device.

FIG. 2 shows a pocket-sized two-dimensional image projection device 20 comprising a light source 22, a lens array 30, and a projection surface 24. The light source 22 may be any conventional light source such as a metal halide with a color wheel, a light emitted diode, a three (Red, Green, Blue) laser diode, or any other suitable light source. The light source generates Red, Green, and Blue (“RGB”) light 21, which is reflected by the lens or lens array 30 according to the image data, and focused onto the projection surface 24 where the resulting image is displayed.

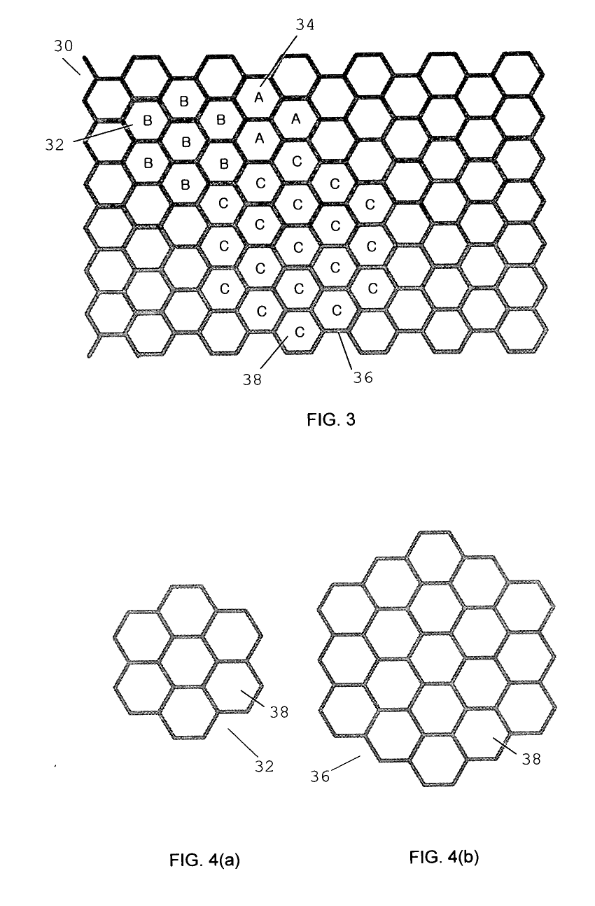

Referring to FIG. 3, the lens array 30 comprises a planar array of micromirror array lenses 32, 34, and 36. Each micromirror array lens comprises a plurality of micromirrors 38. Each micromirror 38 has the same function as a mirror and comprises a reflective surface made of metal, metal compound, or other materials with reflectivity. Many known microfabrication processes can be used to fabricate a surface having high reflectivity. The micromirrors are individually controlled by actuating components that rotate and translate the micromirrors. The micromirrors are preferably parabolic in cross-section. This parabolic construction increases the focusing efficiency of the micromirror array lens, as discussed in further detail below.

The lens array 30 may comprise a series of micromirror array lenses 32, 34, and 36 arranged to form a substantially rectangular array. The basic configuration and operational principle of such a lens array is described in U.S. patent application Ser. No. 10/857,714 (filed May, 28, 2004), the entire disclosure of which is incorporated herein by reference.

As shown in FIGS. 4(a) and 4(b), each micromirror array lens comprises an arbitrary number of micromirrors 38 that may vary in size and shape. However, it is preferred that the micromirrors comprise a hexagonal, rectangular, and/or square shape. These shapes enable the micromirrors to be easily fabricated and controlled.

In other embodiments, a cylindrical lens array or mixed lens array comprising cylindrical and/or circular lenses may be constructed.

Each micromirror array lens exists for a given time. According to the image signal, many different micromirror array lenses are “constructed” and “destroyed” within the frame speed.

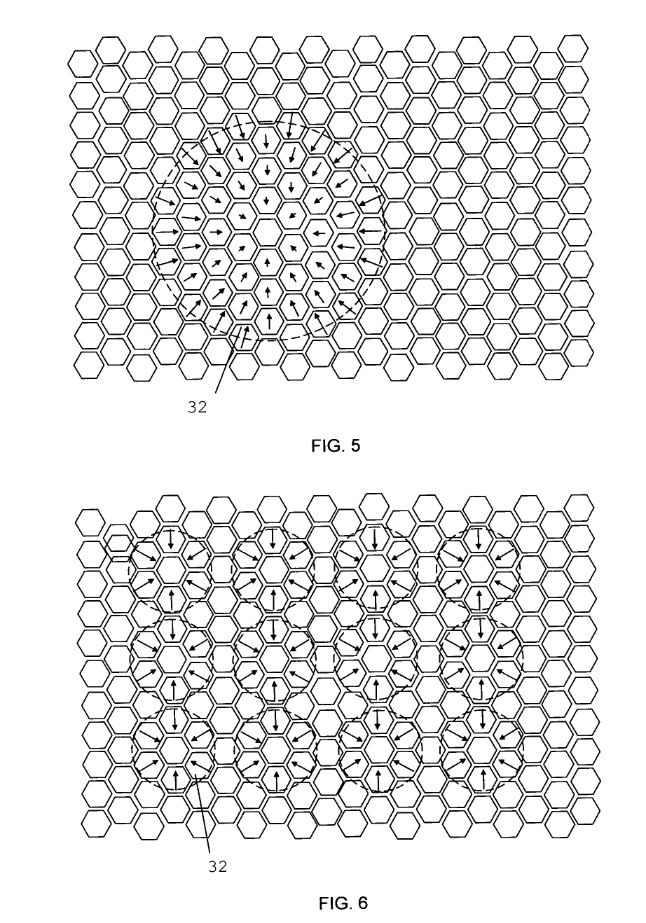

For example, one image frame may only require that the lens array 30 comprise only one micromirror array lens 32, as shown in FIG. 5. However, another image frame may require that the lens array comprises twelve micromirror array lenses 32, as shown in FIG. 6. For the purposes of the present invention, the word “variable” means all optical parameters, focal length, optical axis, lens size, the number of lenses, shape of lens, and others can be changed according to the processed image data.

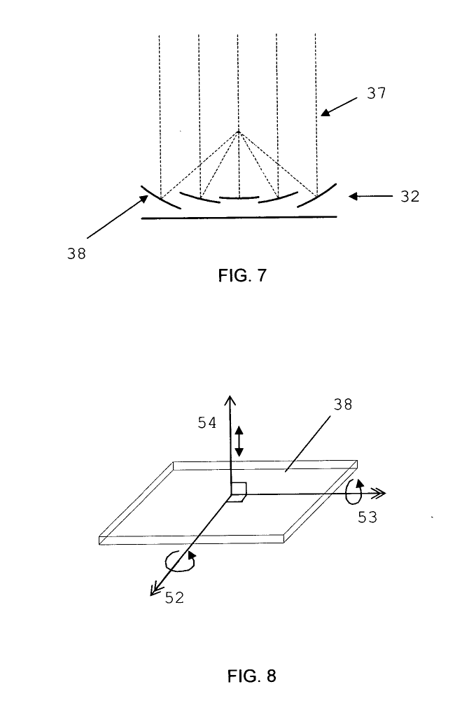

FIG. 7 illustrates how each micromirror array lens 32, 34, or 36 works. The micromirror array lens of the present invention is described in U.S. patent application Ser. No. 10/855,287 (filed May, 27, 2004), the entire disclosure of which is incorporated herein by reference. As described above, the micromirror array lens 32 comprises many micromirrors 38. Each micromirror corresponds to a segment of a circle or a parabola. Unlike conventional concave mirrors, the micromirror array lens can change its focal length and direction of optical axis by controlling the rotation of each segmental micromirror.

The micromirror array lens 32 produces an in-focus image pixel by converging collimated light 37 into one point M (see FIG. 2) on an image plane. This is accomplished by controlling the position of the micromirrors 38. The phases of the arbitrary light may be adjusted with the same phase by translating each micromirror. The required translational displacement range of the micromirrors is at least half of the wavelength of light.

The focal length F of the micromirror array lens 32 is changed by controlling the rotational and/or translational motions of each micromirror 38. Because the micromirrors can have rotational and translational motions, the micromirror array lens can be a Spatial Light Modulator (SLM). The micromirrors retract or elevate to lengthen or shorten the optical path length of light scattered from the image, to remove phase aberrations from the image.

The mechanical structures upholding the micromirrors 38 and the actuating components that rotate and translate the micromirrors are located under the micromirrors to enable the micromirrors to be positioned closer to one another. This increases the effective reflective area of the micromirror array lens 32. Also, electric circuits to operate the micromirrors can be replaced with known microelectronic technologies, such as MOS or CMOS. Applying the circuits under the micromirror array, the effective area can be increased by removing necessary area for the electrode pads and wires used to supply actuating power. Since the micromirrors are small in mass and generate small moments of inertia, their positions and attitudes may be changed at rate of approximately 10 kHz. Therefore, the micromirror array lens becomes a high speed variable focusing lens having a focusing response speed of approximately 10 kHz.

As discussed above, it is desired that each micromirror 38 have a curvature because the ideal shape of a conventional reflective lens has a curvature. However, since the aberration of the micromirror array lens 32 with flat micromirrors is not much different from a conventional lens with curvature if the size of the micromirrors is small enough, there is not much need to control the curvature of the micromirrors.

Accordingly, as shown in FIG. 8, each micromirror 38 of the present invention has three degrees-of-freedom motion, one translational motion 54 along the normal axis to the plane of each micromirror array lens, and two rotational motions 52, 53 about two axes in the plane of each micromirror array lens. The translational motion is required to meet phase matching condition to compensate for aberrations. The two rotational motions are required to deflect light arbitrary direction and are essential for versatility of the array of micromirror array lenses. An array of micromirror array lenses with only two-degree-of-freedom rotational motion is also possible but its image quality may be deteriorated.

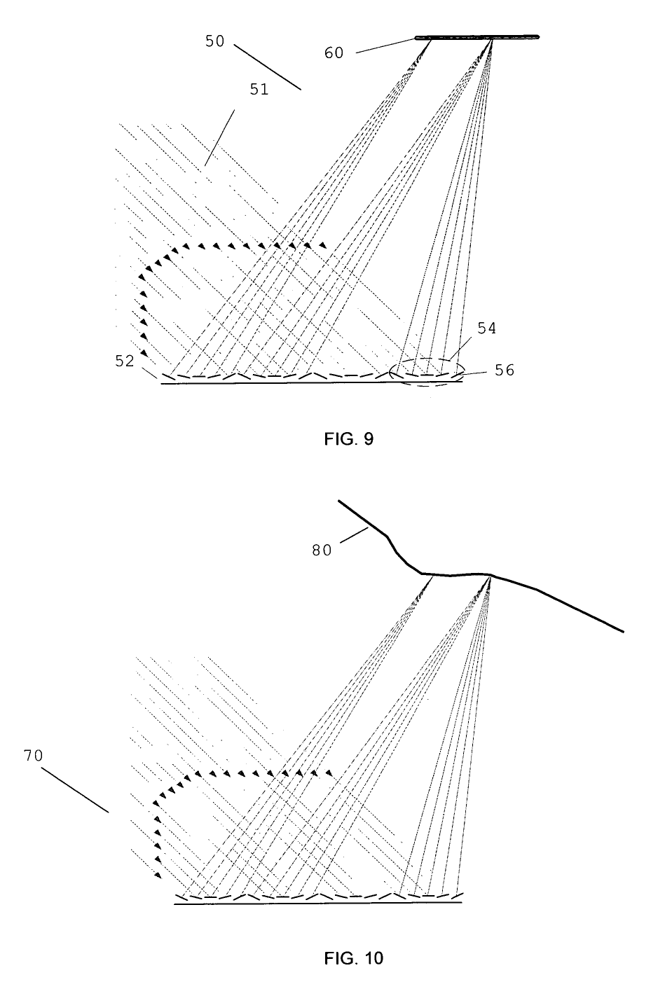

FIG. 9 illustrates the operation of a pocket-sized two-dimensional image projection device 50 comprising a lens array 52 in accordance with principles of the present invention. Accordingly, a light source (not shown) generates collimated light 51 that incidents from the light source to the lens array. The light is reflected from the micromirror array lenses 54 and focused onto a projection surface 60 where the resulting image is viewed.

At any given image frame, the optical axis of a micromirror array lens may vary. Similarly, at any given image frame, the number of micromirrors comprising a micromirror array lens and/or the focal length of a micromirror array lens may vary. Since each micromirror array lens has the ability to scan the in-focused light along the projection surface, any two or more micromirror array lenses can simultaneously focus incident light onto different positions or at the same position on the projection surface. Because each micromirror array lens can scan the partial or whole projection surface 60 (i.e., focus the incident light at any position on the projection surface), the projected image can be generated.

FIG. 10 is a schematic view illustration how the pocket-sized two-dimensional image projection device 70 projects two-dimensional image on a projection surface with arbitrary profile 80 and arbitrary distance from the projection device, and arbitrary attitude about the projection device. For the pocket-sized projection device, arbitrary surface 80 such as desk surface or a wall can be a screen. The position, profile, and attitude of the projection surface about the projection device can be arbitrary because the projection surface is not embodied in the projection device to reduce size of the device. Each micromirror array lens has the ability of scanning and focusing on the projection surface. The focusing on the projection surface can be achieved by automatic focusing function of micromirror array lens as described in U.S. patent application Ser. No. 10/896,146 (filed Jul., 21, 2004). Therefore, an in-focused two-dimensional image can be displayed on arbitrary projection surface 80.

### Random Scanning Technique

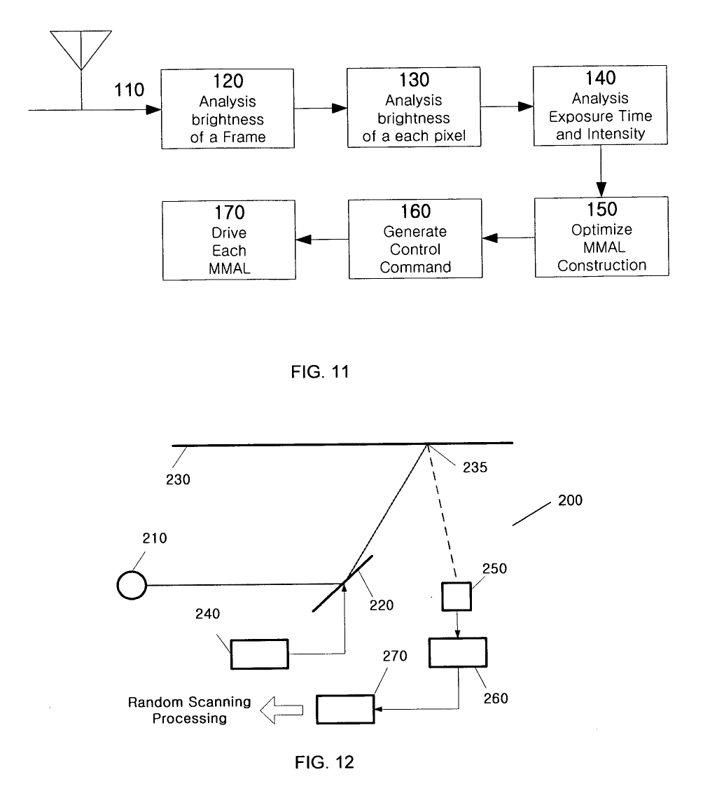

Pocket-sized two-dimensional image projection devices of the present invention may apply a random scanning technique (“RST”) to reduce the required number of micromirror array lenses comprising a lens array. FIG. 11 schematically illustrates how the RST is applied to such image projection devices.

The technique begins with an image signal 110 that is received from an antenna, receiving means, or storage device. The signal is then processed by an image processor that analyses the average brightness of a frame 120. The image processor then analyses brightness of each pixel 130. Next, the image processor calculates the required light intensity and exposure time 140 for each pixel. The image processor then performs optimization 150. Through the optimization, the most optimized set of micromirror array lens combinations which can minimize the movement, minimize construction and destruction of the micromirror array lens, and minimize scanning length for a frame rate is generated. According to the optimized lens combinations, a control command for a frame is generated 160. The control signal is sent to lens array to generate images on the screen. Because the response speed of micromirror array lens (>10 kHz) is much faster than the frame speed (˜30 Hz), a pocket-sized two-dimensional image projection system using array of micromirror array lenses and the random scanning technique can display much more pixels than the number of micromirror array lenses. By changing the number of micromirrors of each micromirror array lens and/or scanning speed (i.e., the duration of light exposure time) of the micromirror array lenses, the gray scale can be expressed easily. The fact that the required number of micromirror array lens is much smaller than the number of pixels makes the array of micromirror array lenses very small in size.

### Self Diagnosis & Correction Technique

A self diagnosis & correction technique (“SDCT”) may also be applied to a pocket-sized two-dimensional image projection device. During the SDTC, the image processor analyzes the deviations of each spot from a predetermined position and correct the scale factor of the corresponding micromirror. A simplified schematic diagram of the SDCT as applied to a pocket-sized two-dimensional image projection device of the present invention is shown in FIG. 12. The SDCT system 200 mainly consists of a light source 210, an image sensor 250, an image processor 260, read only memory (ROM) 270, a lens array 220, and controller 240.

This technique starts with the controller 240. The controller generates and sends a set of test signals to the lens array 220. Each of the micromirrors comprising the array is controlled by the test signal, and incident light from the light source 210 is deflected to several predetermined positions 235 along a projection surface 230 by the controlled micromirrors. The image sensor 250 comprises a photo detector that detects the light spots along the projection surface. The image sensor then sends an electrical signal comprising image data to the image processor 260. The image processor also decides the pass or failure for each micromirror. This test will be done for all micromirrors in the lens array. Because the response speeds of the micromirrors are slightly less than 10 kHz, the entire test can be completed for all micromirrors within a short time. The test also can be done while viewers are watching the image device. The test results for all micromirrors in the array is written in the ROM 270 and become reference data for the random signal processing. In the random scanning processing for a pocket-sized two-dimensional image displaying, the failed micromirrors are excluded in construction of micromirror array lenses.

Through the self diagnose process, failed micromirrors are identified. The random scanning processor optimizes the control signals to exclude failed micromirrors in operation and to compensate for aberrations by adjusting the micromirror array lens combination and scanning speed. By the SDCT, the displayed image can be maintained with the same quality even if as many as ten to twenty percent (10-20%) of micromirrors are failed. By applying SDCT, the reliability and operating lifetime of display device can be much improved.

When applying the present invention to a conventional two-dimensional display devices, the brightness of the projected image and power consumption of the display device are greatly improved by increasing light efficiency over prior art display devices. According to the prior art, the DMD array uses at most fifty percent (50%) of incident light because it has “on” and “off” positions. The light is dumped when the mirror is at “off” position. On the contrary, the array of micromirror array lenses can use most incident light by adopting the optimized Random Scanning Technique. In that regard, the most power consuming element in a two-dimensional display device is projection lamp, and light efficiency is directly related to power consumption.

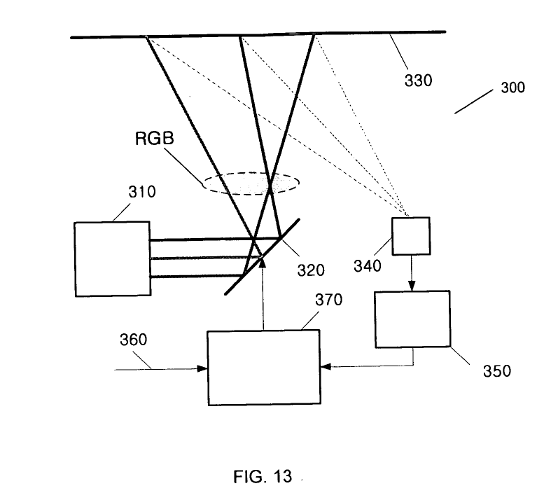

FIG. 13 illustrates a pocket-sized two-dimensional image projector. In this embodiment, to miniaturize the two-dimensional image projector, a three (Red, Green, Blue) laser diode module 310 is used as a light source. To minimize undesirable effects, such as speckle and interference from coherent light, a broad band laser is preferable. An image signal 360 received from a broadcasting system, other outside device, or internal storage device is transmitted to a random scanning processing unit 370, which sends an optimized control signal to construct a lens array 320. The lens array deflects incident light from the laser diode to display an image. The image can be displayed on a screen, wall, or other suitable projection surface 330. An image sensor 340 implemented into the portable electronic device, comprises a photo detector that detects scattered light from the screen. The image sensor generates and sends an electrical signal carrying image data to an automatic focusing image processor 350. The image processor contains an automatic focusing algorithm that analyzes the image data to determine the focusing status. The image processor then sends the focusing status to a random scanning processing unit 370. Random scanning processing unit sends a control signal to the micromirror array lenses to adjust the focusing of each micromirror array lens in the lens array.

Summarily, the present invention improves the brightness and power consumption of conventional two-dimensional image projection systems. The present invention may be adapted to provide portable, pocked-sized, and high quality two-dimensional image projection devices. Each of the micromirror array lenses may be controlled independently to have different focal length, different optical axis, lens size, and lens shape. This enables the lens array to be applied in many applications. Further, each of the micromirror array lenses may be controlled to scan a projection surface with different speeds, or a group of micromirror array lenses may be controlled to scan the same point on a projection surface simultaneously. This makes easy to control the light intensity on the screen.

The preceding description has been presented with reference to presently preferred embodiments of the invention. Workers skilled in the art and technology to which this invention pertains will appreciate that alterations and changes in the described structure may be practiced without meaningfully departing from the principal, spirit and scope of the invention.

Accordingly, the foregoing description should not be read as pertaining only to the precise structures described and illustrated in the accompanying drawings, but rather should be read consistent with and as support to the following claims, which are to have their full and fair scope.

What is claimed is:

1. A pocket-sized two-dimensional image projection device, wherein the projection device is adapted to a portable device, wherein the projection device comprises a micromirror array lens or an array of micromirror array lenses, wherein the micromirror array lens comprise a plurality of micromirrors.

2. The pocket-sized two-dimensional image projection device of claim 1, wherein each micromirror array lens can change its optical property independently.

3. The pocket-sized two-dimensional image projection device of claim 2, wherein each micromirror array lens can change its focal length independently.

4. The pocket-sized two-dimensional image projection device of claim 2, wherein each micromirror array lens can change its optical axis independently.

5. The pocket-sized two-dimensional image projection device of claim 2, wherein the number of micromirrors comprising one micromirror array lens independently varies from the number of micromirrors comprising the other micromirror array lenses.

6. The pocket-sized two-dimensional image projection device of claim 1, wherein the micromirror array lens scans and focuses light on a projection surface, wherein the light is being scanned by traversing the focused light along the surface by a micromirror array lens.

7. The pocket-sized two-dimensional image projection device of claim 6, wherein the projection surface is a plane.

8. The pocket-sized two-dimensional image projection device of claim 6, wherein the projection surface has arbitrary profile and the light is focused on the arbitrary profile.

9. The pocket-sized two-dimensional image projection device of claim 6, the projection surface is located at the arbitrary distance from the projection device and the light is focused on the projection surface at the arbitrary distance.

10. The pocket-sized two-dimensional image projection device of claim 6, the projection surface is a desk surface.

11. The pocket-sized two-dimensional image projection device of claim 6, the projection surface is a wall.

12. The pocket-sized two-dimensional image projection device of claim 6, wherein each micromirror array lens scans light along the projection surface independently.

13. The pocket-sized two-dimensional image projection device of claim 6, wherein several micromirror array lenses scan the same positions in the projection surface simultaneously.

14. The pocket-sized two-dimensional image projection device of claim 6, wherein each of the micromirror array lenses scan the projection surface at different speeds.

15. The pocket-sized two-dimensional image projection device of claim 6, wherein the device scans the projection surface using the random scanning technique.

16. The pocket-sized two-dimensional image projection device of claim 6, wherein a gray scale is achieved by changing the scanning speed of the micromirror array lens.

17. The pocket-sized two-dimensional image projection device of claim 6, wherein a gray scale is achieved by varying the number of micromirrors of each micromirror array lenses.

18. The pocket-sized two-dimensional image projection device of claim 6, wherein a gray scale is achieved by changing the number of micromirror array lenses simultaneously focused at a point on the projection surface.

19. The pocket-sized two-dimensional image projection device of claim 6, wherein a gray scale is achieved by changing the scanning speeds and sizes of the micromirror array lenses.

20. The pocket-sized two-dimensional image projection device of claim 1, wherein each micromirror has three degrees-of-freedom motion.

21. The pocket-sized two-dimensional image projection device of claim 6, wherein the device identifies defective micromirrors and re-calibrates the device by excluding the defective micromirrors and adjusting the combination of micromirror array lenses and respective speeds to scan the projection surface.

22. The pocket-sized two-dimensional image projection device of claim 1, further comprising:
a light source that generates collimated light, wherein the light is reflected by the array of micromirror array lenses and focused at a point in space;
a projection surface for displaying an image, wherein the light reflected by a micromirror array lens or the array of micromirror array lenses is focused onto projection surface;
an image sensor comprising a photo detector that detects light spots on the projection surface, the image sensor generating an data signal comprising image data;
an image processor in communication with the image sensor, wherein the image processor receives the data signal sent by the image sensor; and
a controller that generates and sends to each the micromirror array lenses an control signal comprising control data to adjust the configuration of the micromirror array lenses.

23. The pocket-sized two-dimensional image projection device of claim 22, wherein the focused light corresponds to a pixel of a displayed image.

24. The pocket-sized two-dimensional image projection device of claim 1, wherein the projection device uses automatic focusing signal processing.

25. The pocket-sized two-dimensional image projection device of claim 1, further comprising:
a light source that produces collimated light, wherein the light is deflected by a micromirror array lens or the array of micromirror array lenses and focused at a point in space; and
a projection surface for displaying an image, wherein the light deflected by one micromirror array lens or array of micromirror array lens is focused onto the projection plane and an image is displayed;

26. The image projector of claim 25, further comprising:
an image sensor comprising a photo detector that detects scattered light from the image, wherein the image sensor generates a data signal comprising image data;
an image processor in communication with the image sensor, wherein the image processor receives the data signal sent by the image sensor, analyzes the image data, and generates a status signal comprising image focusing status data; and
a random scanning processing unit in communication with the image processor, wherein the random scanning processing unit receives the status signal sent by the image processor, and generates a control signal that is sent to the array of micromirror array lenses to adjust the focus of each micromirror array lens.

27. The pocket-sized two-dimensional image projection device of claim 1, wherein the projection device uses a method of random scanning technique; comprising:
analyzing brightness of a frame;
analyzing brightness of each pixel;
calculating exposure time and intensity;
optimizing the construction of micromirror array lens;
generating control command; and
driving each micromirror array lens;

28. The pocket-sized two-dimensional image projection device of claim 1, wherein the projection device uses a method of self diagnosis and correction; comprising:
identifying defective micromirrors;
re-calibrating by excluding the defective micromirrors; and
adjusting the combination of micromirror array lenses and respective speeds to scan the projection surface;

29. The pocket-sized two-dimensional image projection device of claim 1, wherein the projection device uses a method of focusing light at a point on a projection surface; comprising:
generating light from a light source;
providing an array of micromirror array lenses comprising a plurality of micromirrors which reflect and focus the light onto the projection surface, wherein the focused light corresponds to a pixel of a displayed image;
receiving an image signal comprising image data, wherein the image data is transmitted to a processing unit and the processing unit sends an optimized control signal to the array of micromirror array lenses to adjust the focus of each micromirror array lenses;
detecting light scattered from the displayed image to generate a data signal carrying image data;
analyzing the data signal to produce a status signal carrying image focusing status data; and
processing the image focusing status data to produce a control signal that is sent to the array of micromirror array lenses to adjust the focusing of each of the micromirror lenses in the array.

30. The method of claim 29, wherein the optimized control signal carries data to produce the most optimized set of micromirror array lens combinations.

31. The pocket-sized two-dimensional image projection device of claim 1, wherein the projection device uses a method of displaying an image on a projection surface, comprising:
generating light from a light source;
providing an array of micromirror array lenses comprising a plurality of micromirrors which reflect and focus the light onto the projection surface, wherein the focused light corresponds to a pixel of the displayed image;
receiving an image signal comprising image data, wherein the image data is transmitted to a processing unit and the processing unit sends a control signal to the array of micromirror array lenses to adjust the focus of each micromirror array lenses; and
focusing the light randomly at certain positions corresponding to the image data along the projection surface where the image is displayed.

32. The pocket-sized two-dimensional image projection device of claim 1, wherein the portable device is a mobile phone.

33. The pocket-sized two-dimensional image projection device of claim 1, wherein the portable device is a personal digital assistant.

34. The pocket-sized two-dimensional image projection device of claim 1, wherein the portable device is a camcorder.

35. The pocket-sized two-dimensional image projection device of claim 1, wherein the portable device is a camera.

36. The pocket-sized two-dimensional image projection device of claim 1, wherein the portable device is an organizer.

37. The pocket-sized two-dimensional image projection device of claim 1, wherein the portable device is a portable DVD player.

38. The pocket-sized two-dimensional image projection device of claim 1, wherein the portable device is a laptop computer.
